(19) United States
(12) Patent Application Publication
(10) Pub. No.: US 2017/0066490 A1
(43) Pub. Date: Mar. 9, 2017

(54) ROBOT UNIT FOR TRANSPORTING LONG LOADS

(71) Applicant: SIGMA Clermont, AUBIERE (FR)

(72) Inventors: Jean-Christophe FAUROUX, MAZAYES (FR); Belhassen-Chedli BOUZGARROU, CLERMONT-FERRAND (FR); Mohamed KRID, AUBIERE (FR)

(21) Appl. No.: 15/122,084

(22) PCT Filed: Feb. 27, 2015
(86) PCT No.: PCT/FR2015/050483

§ 371 Date: Aug. 26, 2016

(30) Foreign Application Priority Data
Feb. 28, 2014 (FR) 14/51661

(51) Int. Cl. B62D 57/024; B25J 9/02; B60P 3/40; B25J 5/00

(52) U.S. Cl. CPC B62D 57/024; B25J 5/007; B25J 9/026; B60P 3/40

(57) ABSTRACT

The invention relates to a load transporting mono-robot (10), comprising (i) a gantry (19) having two lateral uprights (11) that are connected at their upper ends by a cross beam (12), each of the lower ends being equipped with propulsion means linked to the upright (11) by a motorized pivot (18), and (ii) means for gripping a load that are positioned between the lateral uprights (11) linked to the cross beam (12) by a kinematic chain for positioning and orientation that is configured to allow the means for gripping a load to rotate about an axis substantially normal to the cross beam (12) and is located substantially in the plane defined by the gantry (19), and to allow the means for gripping a load to rotate about an axis substantially normal to the plane defined by the gantry (19). The invention also relates to a method for transporting a load that uses a plurality of mono-robots (10) and also to two methods for crossing obstacles, ensuring the stability of a poly-robot and its load.

### RELATED APPLICATIONS

This application is a National Phase Application of Patent Application PCT/FR2015/050483 filed on Feb. 27, 2015, which claims the benefit of and priority to French Patent Application No. 14/51661 filed Feb. 28, 2014, the contents each of which are incorporated herein by reference in their entirety.

### TECHNICAL FIELD

The present invention concerns a mono-robot for transporting long loads and a method for transporting long loads using this mono-robot.

### BACKGROUND

The transport of a long load such as, for example, a pipeline segment, a wind turbine blade, a stretcher or a beam or construction reinforcements, may prove to be difficult due to the length of the load itself.

Traditionally, the mechanized transport of a long load is performed by a vehicle having a chassis on which the load is positioned as is the case of vehicles presented in the patents EP 1465789 and EP 2328795.

However, the positioning of the load on this type of vehicle requires the use of an external machine such as a lifting truck or a jib crane.

Furthermore, the vehicles of the prior art are often standardized and may not be adapted to the load to be transported. Furthermore, due to the presence of a long chassis and the length of the load to be transported, the vehicles of the prior art may only move forward with difficulty over rough terrain.

### BRIEF SUMMARY

In this technical context, an object of the present invention is to provide a transport solution of long loads easy to be loaded, adaptable to the type of load to be transported and may cross obstacles.

In the present document, mono-robot, unitary robot, and poly-robot are defined as a combination of several mono-robots working together.

According to a general definition, the invention relates to a load transporting mono-robot which comprises a gantry crane with lateral uprights connected at their upper ends by a transverse beam, each of the lower ends being equipped with propulsion means connected to the upright by a driven pivot. The mono-robot further comprises, gripping means of a load positioned between the lateral uprights, and connected to the transverse beam by a positioning and orientation kinematic chain. The positioning and orientation kinematic chain is configured to allow the rotation of the gripping means of a load about an axis substantially normal to the transverse beam and substantially belonging to the plane defined by the gantry crane, and the rotation of the gripping means of a load about an axis substantially normal to the plane defined by the gantry crane.

The invention then provides a mono-robot, allowing a ventral seizing of an object to be transported. It about an important point of the invention because the ventral transport of a load allows the assembly comprising of a mono-robot and a load to keep a high stability by presenting a center of gravity close to the ground.

The mono-robot according to the invention is, moreover, easily configurable in order to perform the transport of any type of load.

The invention can thus be adapted to a wide variety of geometries and masses of the loads to be transported as the mono-robot may be fastened at any point of the load. It is possible to combine several mono-robots on a same load for distributing the mechanical forces.

Furthermore, each mono-robot can perform complex movements which allow it to cross obstacles when implemented with other mono-robot for transporting a load. The mono-robot has thus a great agility which distinguishes it from the long loads transporting vehicles of the prior art.

Furthermore, the positioning and orientation kinematic chain connecting the gripping means to the transverse beam may be configured to allow the translation of the gripping means of a load along a direction substantially normal to the plane defined by the gantry crane.

In this manner, the mono-robot may be displaced along a load in order to cross an obstacle or to optimize the position of the center of gravity of the load with respect to the bearings of the mono-robot.

Preferably, the positioning and orientation kinematic chain may be configured to allow the translation of the gripping means of a load in the plane defined by the gantry crane along a direction normal to the transverse beam.

Thus the mono-robot according to the invention presents a fast loading and easy implementation mode. Indeed, the positioning and orientation kinematic chain allows the gripping means to seize the load on the ground and to lift it for transport. The mono-robot can then seize a load placed on the ground by standing directly over the concerned load, without recourse to annex lifting equipment.

Furthermore, the gripping means of a load are connected to the transverse beam by the positioning and orientation kinematic chain comprising kinematic connections of the cylindrical, rotoid, prismatic or universal group. Furthermore, the finger-spherical connection has the same degrees of freedom as a universal type connection and may be substituted therefor. It is specified that the positioning and orientation chain may have a serial or parallel architecture (open or closed) with one or more contours.

Thus, the gripping means have all the degrees of freedom and all the movements required for seizing the load. Furthermore, the positioning and orientation kinematic chain allows displacements of the mono-robot relative to the transported load to better adjust the position of its center of gravity. The positioning and orientation kinematic chain also allows the mono-robot to displace one of the propulsion means in the three dimensions of the space by bearing on the other propulsion means.

According to a preferred embodiment, the propulsion means belong to the group comprising: a wheel, a caterpillar and an omnidirectional wheel.

According to one embodiment, each lower end of the gantry crane is equipped with a single wheel connected to the upright by a driven pivot. Other embodiments are possible by equipping each lower end of the gantry crane of an omnidirectional wheel or a caterpillar.

Furthermore, a gripping means of a load comprises a clamp having one or more jaws configured to seize and retain a load, each jaw being equipped with a movable end roller in rotation relative to the jaws and allowing the translation of a load with respect to the jaw, and at least one latch adapted to immobilize in rotation one or more rollers relative to the jaw.

This technical disposition allows displacing the mono-robot with respect to the load seized by the gripping means. Furthermore, the latches are used to allow accurately adjusting the position of a mono-robot along the seized load and locking said position.

The present invention also concerns a method for transporting a load by a load transporting poly-robot which comprises the following steps:
supply of number M of mono-robots with M greater than or equal to 2;
distribution of the mono-robots along a load;
gripping by the gripping means of each mono-robot of said load or an intermediate chassis connected to a load;
lifting of the load;
actuation of the propulsion means of each mono-robot.

The invention thus allows the transport of a long load by several mono-robots whose displacements are coordinated. According to this aspect of the invention, the load fulfils the function of chassis which connects at least two mono-robots. The invention thus becomes a poly-robot without chassis as the chassis function is carried out by the load to be transported itself. This disposition of the invention is quite advantageous in that it allows the economy of a chassis which is costly and cumbersome.

Furthermore, the invention provides a method for transporting a load by a load transporting poly-robot which comprises the following phases of crossing an obstacle:
positioning the poly-robot against an obstacle;
for each mono-robot m (m=1 . . . M) of the poly-robot:
   reconfiguration phase of the assembly of the poly-robot to maximize its stability in anticipation of the raising of a propulsion means of the mono-robot m,
   raising of a first propulsion means of the mono-robot m at an altitude greater than the altitude of the obstacle;
   crossing phase of the obstacle by the first propulsion means of the mono-robot m,
   landing phase on the obstacle of the first propulsion means of the mono-robot m,
   reconfiguration phase of the assembly of the poly-robot to maximize its stability in anticipation of the raising of the second propulsion means of the mono-robot m,
   raising of the second propulsion means of the mono-robot m at an altitude greater than the altitude of the obstacle;
   crossing phase of the obstacle by the second propulsion means of the mono-robot m,
   landing phase on the obstacle of the second propulsion means of the mono-robot m.

Advantageously, the reconfiguration of the poly-robot before crossing the obstacle by a wheel allows the invention to remain stable for all the duration of crossing the obstacle. Thus, the invention allows crossing an obstacle by at least two mono-robots transporting a load. The combination of ventral gripping and mono-robots endowed with a complex connection kinematic chain allows the crossing of significant obstacles.

Furthermore, the reconfiguration phase includes one or more following steps and intended for stabilization:
translation of substantially longitudinal axis of a mono-robot m relative to the load so as to approach said mono-robot to the center of gravity of the load;
rotation of substantially vertical axis of a mono-robot m relative to the load so as to approach a propulsion means bearing on the ground of the mono-robot m to the position of the propulsion means which will be subsequently lifted by a mono-robot m+1.

By being thus positioned, the mono-robots—whose number is at least two—allow the poly-robot to increase its stability during the lifting of a wheel.

Advantageously, the crossing phase of an obstacle according to the invention allows a mono-robot to cross obstacles having a significant height by bearing both on its first wheel and the rest of the poly-robot in order to lift its second wheel.

According to another embodiment, the invention provides a method for transporting a load by a load transporting poly-robot comprising two mono-robots. Said method comprises the following steps of front crossing of an obstacle:
rotation of substantially longitudinal axis of a mono-robot allowing the positioning, at an altitude greater than the altitude of the obstacle, of the propulsion means which crosses the obstacle;
rotation of substantially vertical axis of the mono-robot, allowing the positioning of the propulsion means lifted above the obstacle;
rotation of substantially longitudinal axis of the mono-robot allowing the propulsion means to be placed on the obstacle.

In another embodiment, the invention concerns a method for transporting a load by a load transporting poly-robot comprising at least three mono-robots presenting the phases of front crossing of an obstacle comprising the steps of:
positioning the load transporting poly-robot against an obstacle;
for each of the successive mono-robots of the poly-robot, a front crossing phase in three steps:
   translation of substantially vertical axis of the mono-robot considered at an altitude greater than the altitude of the obstacle;
   advance of the poly-robot and the load over the obstacle until bringing the next mono-robot against the obstacle;
   translation of substantially vertical axis of the mono-robot considered to allow it to place its propulsion means on the obstacle.

The front crossing phase of an obstacle according to the invention allows a poly-robot including at least three mono-robots to cross obstacles having a significant height by bearing on at least two mono-robots bearing on the ground.

### BRIEF DESCRIPTION OF THE DRAWINGS

Other features and advantages of the invention will become clear from the following description with reference to the appended drawings which show several embodiments of the invention.

FIG. 1 is a schematic perspective view of a mono-robot according to the invention;

FIG. 2 is a perspective view of a long load transporting poly-robot according to the invention in an implementation of the invention with two mono-robots;

FIG. 3 is a schematic perspective view of another embodiment of a long load transporting poly-robot using a longitudinal translation means of the load by a specific gripper with rolling rollers, in an implementation with two mono-robots;

FIG. 4 is a schematic perspective view of a poly-robot transporting a flexible load stiffened by an intermediate chassis;

FIGS. 5 to 55 show in top, perspective and side views, a crossing mode of an obstacle by a poly-robot comprising two mono-robots.

FIGS. 56 to 79 illustrate in top and side views, a crossing mode of an obstacle by a poly-robot comprising at least three mono-robots.

### DETAILED DESCRIPTION

In the present document, the following axes are conventionally defined:
longitudinal axis, an axis substantially normal to the plane defined by the gantry crane;
vertical axis, an axis substantially comprised in the plane defined by the gantry crane and perpendicular to the transverse beam;
transverse axis, an axis substantially belonging to the plane defined by the gantry crane and parallel to the transverse beam.

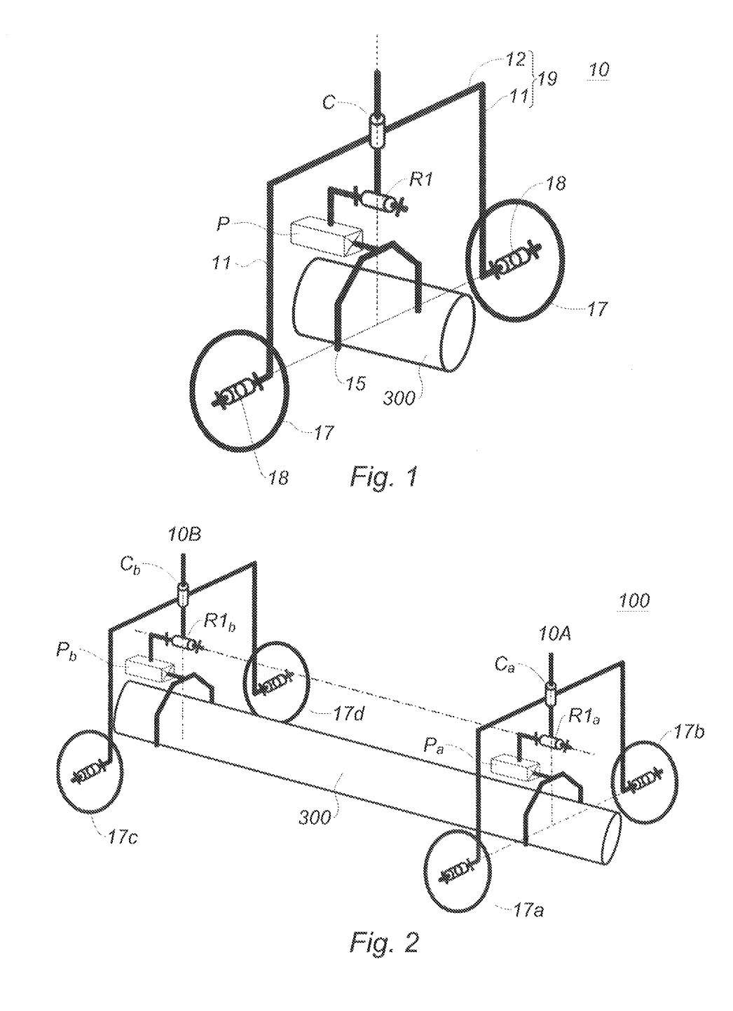

As shown in FIG. 1, the transport mono-robot 10 has a generally reverse U-shaped structure and comprises two lateral uprights 11 and a transverse beam 12, forming a gantry crane 19.

The end of each lateral upright 11 comprises a propulsion means, for example a wheel 17 connected to the upright 11 by a driven pivot 18.

It might be also envisaged to replace the wheels by omnidirectional wheels, caterpillars or any other propulsion means.

The mono-robot 10 is herein, schematically represented. The gantry crane may be composed of mechanically welded metal members or appropriately assembled composite members.

Furthermore, the mono-robot 10 comprises gripping means positioned in the gantry crane 19 between the lateral uprights 11, so as to enable seizing a load.

According to the embodiment shown herein, the gripping means are connected to the beam 12 by a positioning and orientation kinematic chain comprising a prismatic connection (or slide) P of substantially longitudinal axis, a rotoid connection R1 (or pivot) of substantially longitudinal axis and a cylindrical connection C (or sliding pivot) of a substantially vertical axis.

These orientations are specified in the neutral position shown by FIG. 1.

It is specified that some or all of the connections P, R1 and C may be driven.

It must be specified that the connections P, R1 or C are described by way of example and that other chains with serial or parallel structures may be considered.

Furthermore, the stabilization of the mono-robot 10 during its displacement may be ensured by sensors controlling the acceleration, the rotations and the translations of the mono-robot 10. According to other embodiments, the stabilization of the mono-robot 10 may be performed by an additional rolling member connected to the gripping means 15 or connected to a pole fastened to the gantry crane 19.

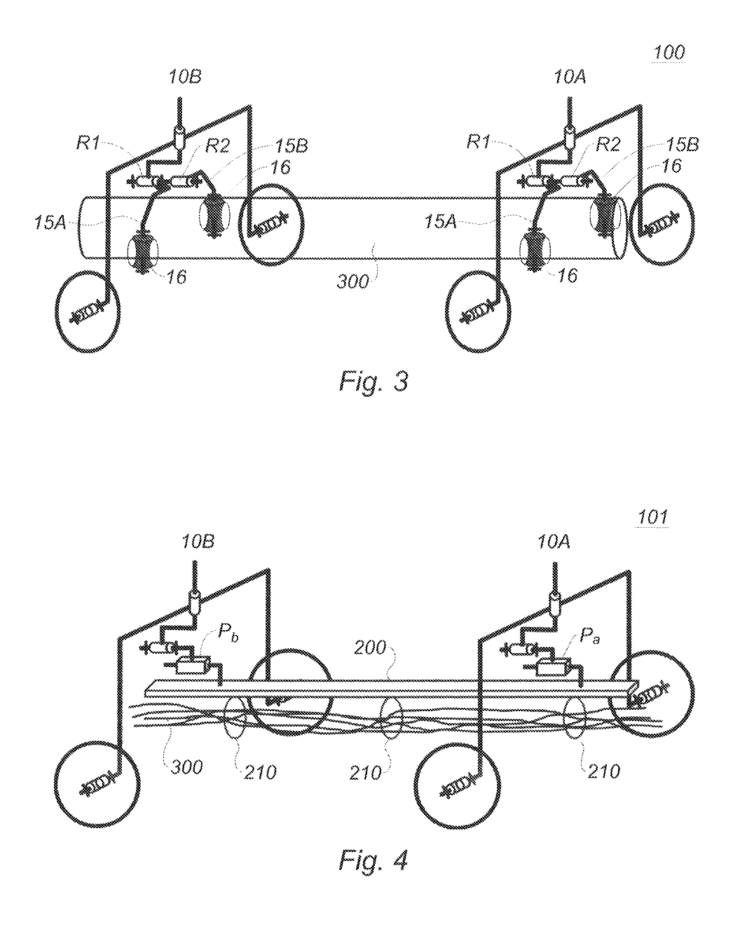

As it may be seen in FIG. 3, the gripping means may comprise a clamp 15 comprising two jaws 15A and 15B connected for example by a pivot R2 to enable seizing a long load 300. In other non-illustrated embodiments of the invention, the clamp 15 may have a jaw which exerts a holding on a fixed surface; it is also conceivable to provide the clamps with more than two jaws (3, 4 or more).

Furthermore, as it is visible in FIG. 3, each jaw 15A-15B of the clamp 15 may be connected to a rotatably movable roller 16. When the clamp 15 supports a load 300, the rotation of the rollers 16 allows the translation of the load 300 and may then ensure the function of the prismatic connection P.

Furthermore, the rollers 16 may be locked in rotation to block the position of a mono-robot 10A-10B relative to the load 300.

When seizing a load 300, the clamp 15 descends by performing a vertical translation due to the cylindrical connection C. Then when the clamp 15 clasps the load 300, the load 300 is lifted by a vertical translation of the clamp 15 due to the cylindrical connection C.

The poly-robot 100 as described in FIGS. 2 and 3 can indifferently handle two types of loads: on the one hand, the load alone if it is sufficiently stiff; on the other hand, an assembly comprising of an intermediate chassis 200 on which a load 300 is fastened in the case where the latter proves to be too soft to ensure the mechanical connection between the mono-robots 10 of the poly-robot 100 (FIG. 4).

As shown in FIG. 2, a poly-robot 100 for transporting long load 300 may be carried out by using at least two mono-robots 10A and 10B.

Two mono-robots 10A and 10B are positioned along the load 300. It is thus seen that the load 300 ensure the function of intermediate chassis of the poly-robot 100 being blocked in the gripping means 15 of each mono-robot 10A and 10B.

In this embodiment, it may be appreciated that the load 300 fulfils the function of connection member between the mono-robots 10. Thus, this implementation avoids the use of a chassis which is commonly found in the devices of the prior art, which is an important advantage of the invention. This embodiment allows a weight gain and allows the poly-robot to transport a long load on rough terrain hardly accessible to the devices of the prior art.

In another embodiment shown in FIG. 4, when the long load 300 does not have sufficient mechanical strength to ensure the function of the intermediate chassis between the two mono-robots 10A-10B, it may be expected to add to the load an intermediate stiffening chassis. In the example shown in the figures, the intermediate chassis is formed by a profile 200. The profile 200 may comprise a series of clips 210 which allow the connection of the long load 300 to the profile 200.

In this case, the clips 210 are mechanical, but it is possible to consider, for example, electromagnetic or pneumatic clips 210 to be adapted for any type of load 300.

The driven pivots 18 allow the poly-robot 100 to roll in a straight line, and to perform a turn by acting on the rotation speeds of each of the wheels, for example by differentiating the rotation speed of the two wheels 17 of a same mono-robot 10 selected depending on the desired trajectory.

The control and coordination of the positioning and orientation kinematic chain of the wheels 17 may be carried out by a monitoring electronic such as, for example, a microcontroller. It is possible to provide an on-board control console, or it is also possible to provide a wireless remote control system.

Furthermore the positioning and orientation kinematic chain of each mono-robot 10A and 10B allows the poly-robot 100 to cross an obstacle.

The invention may be implemented by a poly-robot 100 which comprises at least two mono-robots 10.

The crossing of an obstacle may be performed by adjusting the position of the center of gravity of the poly-robot 100 to optimize the balance so as to allow successively lifting each of the wheels 17 while guaranteeing the permanent quasi-static balance of the system.

For its best understanding, the crossing method of an obstacle by a poly-robot 100 comprising at least two mono-robots 10 is detailed hereinafter.

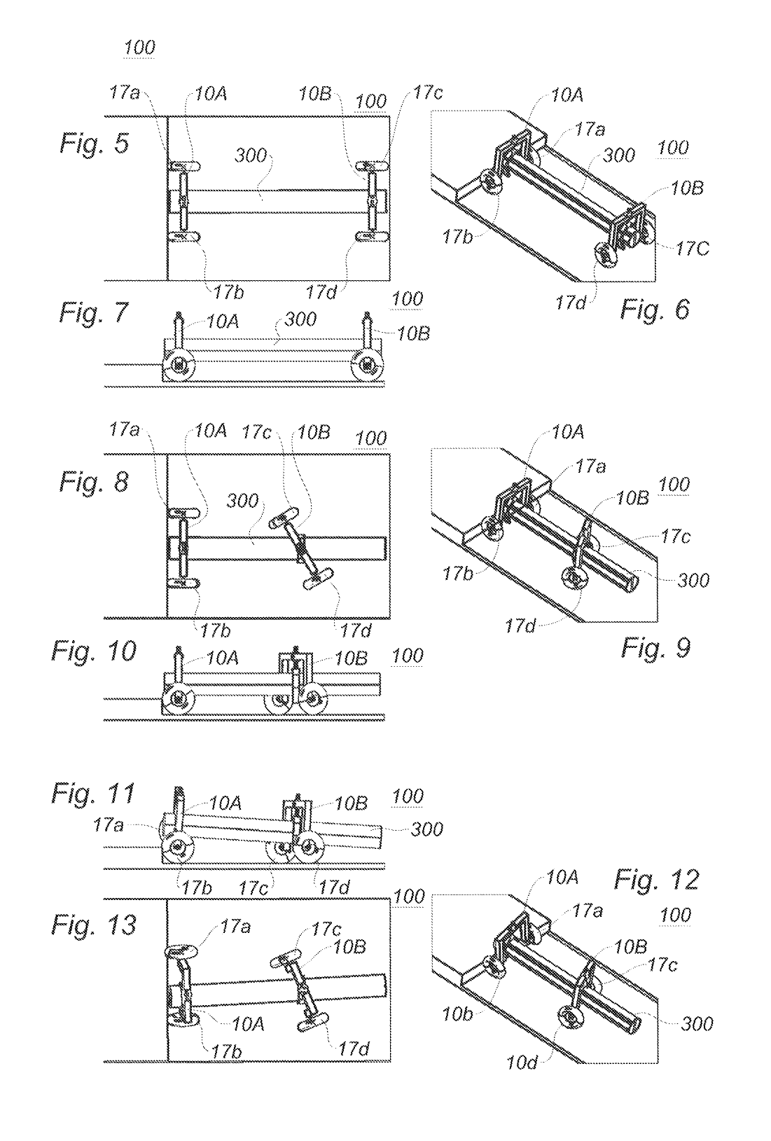

During the rolling, the poly-robot 100 may meet an obstacle as illustrated in FIGS. 5-6-7.

The crossing of an obstacle is made according to a succession of sequences comprising the phases of: reconfiguration, crossing, reconfiguration, crossing, rolling, and this, as many times as required for each of the mono-robots M of the poly-robot.

For the sake of simplicity, the following description is made in relationship relative to a poly-robot 100 comprising two mono-robots 10. It is understood that the invention is applied to a poly-robot 100 which may include M (with M greater than or equal to 2) mono-robots according to the load to be transported.

In the example of a poly-robot with two mono-robots 10A and 10B, so that the poly-robot 100 is stable when lifting the wheel 17a, the poly-robot 100 initiates a reconfiguration phase (FIGS. 8-9-10). The mono-robot 10B is oriented to position the projection of the center of gravity of the poly-robot 100 in the sustenance triangle formed by the wheels 17b, 17c and 17d, as far as possible from the edges of said sustenance triangle.

The mono-robot 10B performs a substantially longitudinal axis translation along the load 300 by means of the prismatic connection Pb, and a rotation about the substantially vertical axis due to the cylindrical connection Cb. The poly-robot 100 is then in the position illustrated in FIGS. 8-9-10.

As shown in FIGS. 11-12-13, the crossing of the obstacle is initiated by the raising of the wheel 17a. The wheel 17a is raised by a rotation of substantially longitudinal axis of the mono-robot 10A around the load 300 due to the rotoid connection R1a or R1b.

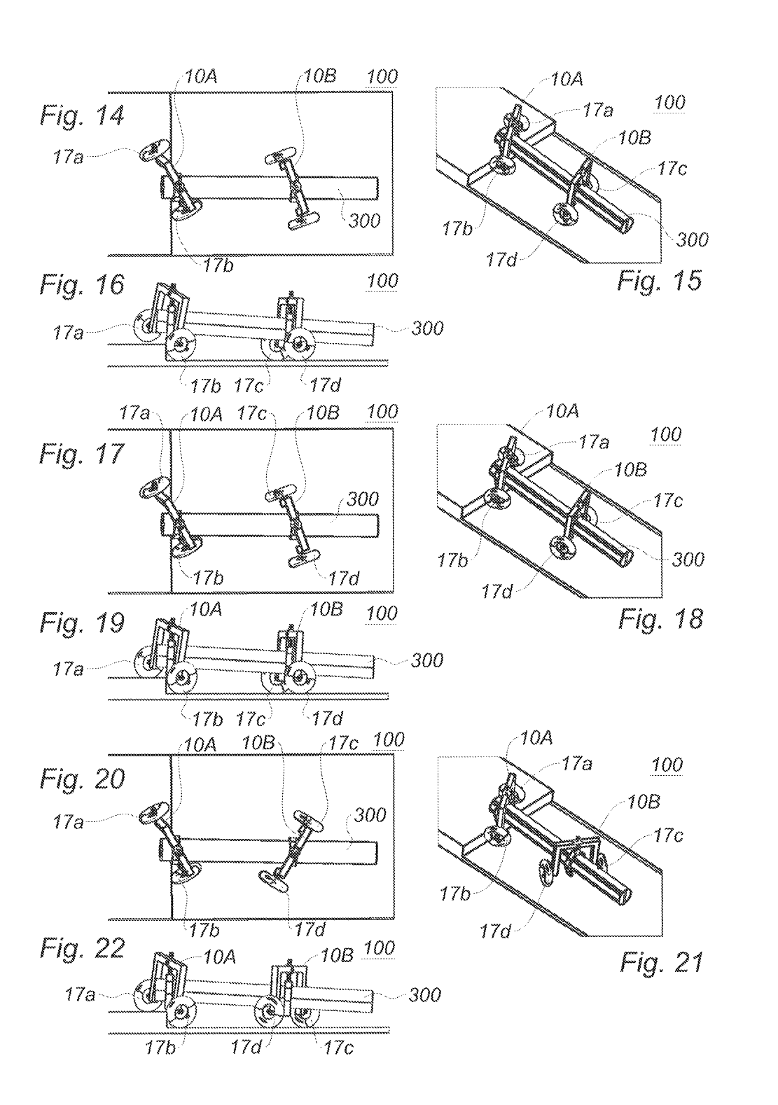

The thrust of the mono-robot 10b and the wheels 17c-17d then causes a rotation of substantially vertical axis of the cylindrical connection Ca of the mono-robot 10A and the positioning of the wheel 17a above the obstacle as it is visible in FIGS. 14-15-16.

Then a rotation of substantially longitudinal axis of the mono-robot 10A allows the bearing of the wheel 17a on the obstacle, as shown in the FIGS. 17-18-19.

As it may be seen in FIGS. 20-21-22, the mono-robot 10B is oriented to position the projection of the center of gravity of the poly-robot 100 within the sustenance triangle formed by the wheels 17a, 17c and 17d, as far as possible from the edges of said sustenance triangle. The orientation of the mono-robot 10B is carried out as described hereinabove.

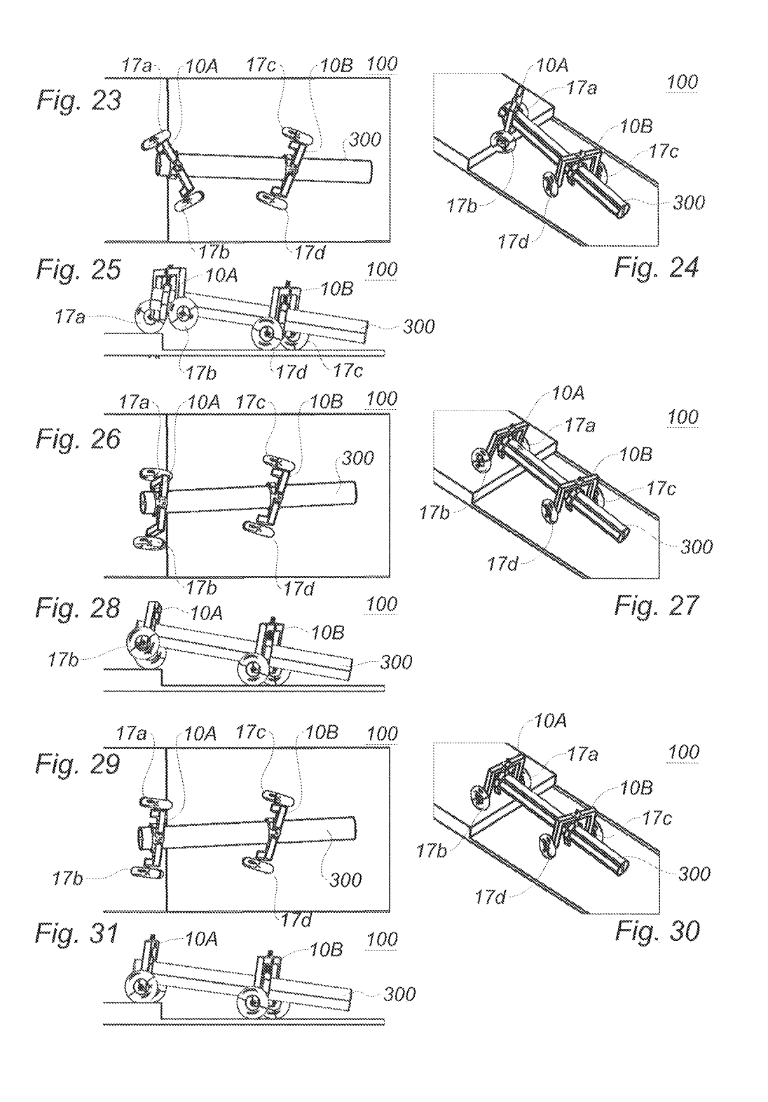

Analogously to what the wheel 17a, 17b has undergone, the wheel is raised as shown in FIGS. 23-24-25.

The wheel 17b is then positioned above the obstacle, as seen in FIGS. 26-27-28, then placed on the obstacle as illustrated in FIGS. 29-30-31. Thus the wheel 17b can cross the obstacle. The poly-robot 100 then performs a rolling phase.

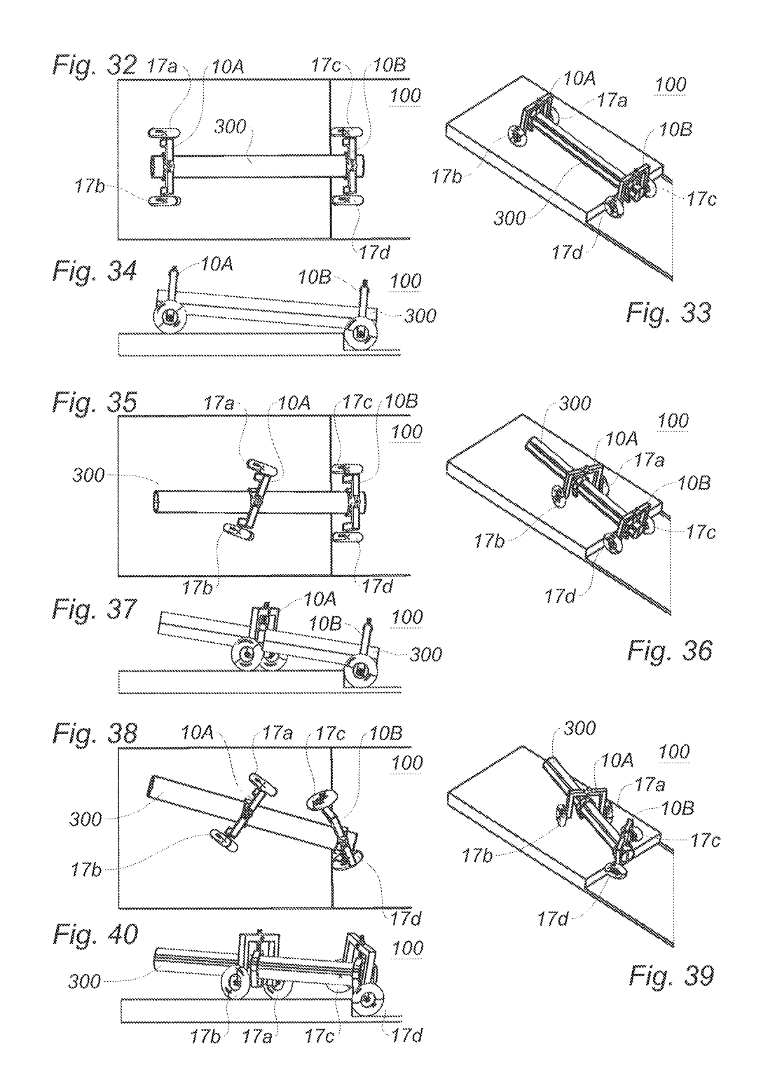

As observable in FIGS. 32-33-34, the mono-robots 10A and 10B, each performs a rotation of substantially vertical axis in order to be positioned in rolling position in a straight line. The poly-robot 100 then moves forward so as to position the mono-robot 10B against the obstacle.

As illustrated in FIGS. 35-36-37, before lifting the wheel 17c of the poly-robot 100, the poly-robot performs a reconfiguration phase. The mono-robot 10A is oriented so as to position the projection of the center of gravity of the poly-robot 100 within the sustenance triangle formed by the wheels 17a, 17b and 17d, as far as possible from the edges of said sustenance triangle.

The wheel 17c can thus initiate the crossing of the obstacle. For this, the wheel 17c is lifted as visible in FIGS. 38-39-40.

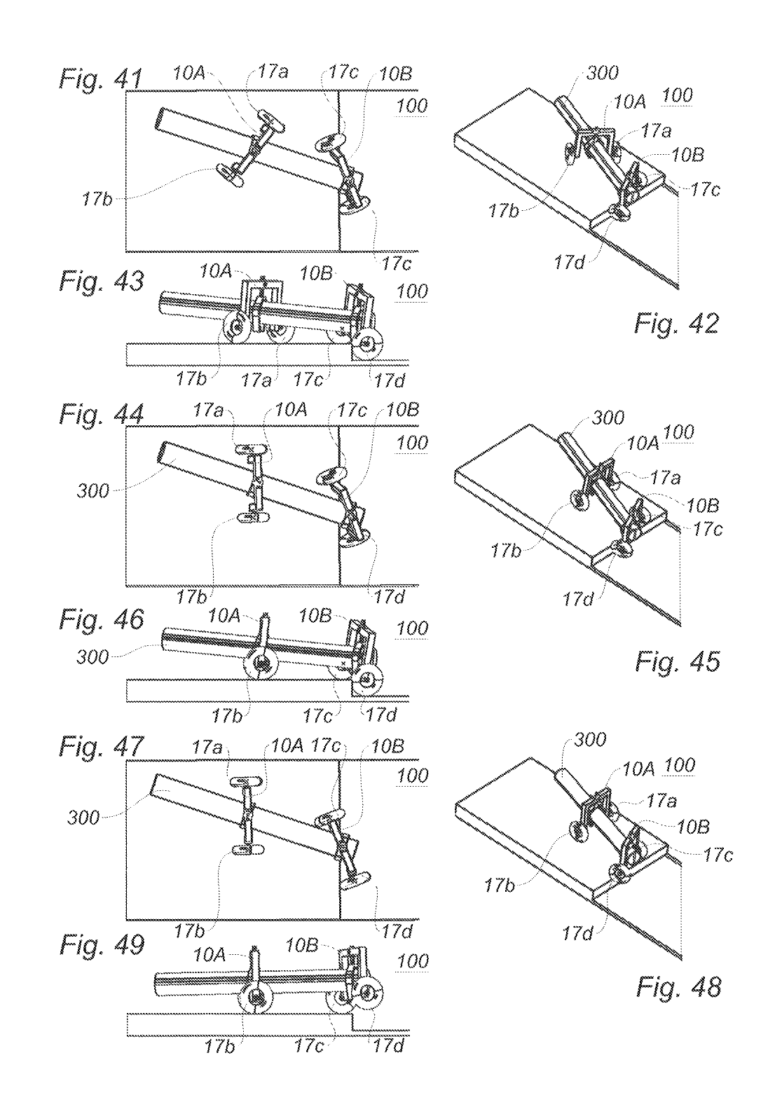

The wheel 17c is positioned above the obstacle, and then is placed on the obstacle as visible in FIGS. 41-42-43.

As shown in FIGS. 44-45-46, in order to lift the wheel 17d, the poly-robot 100 carries out a reconfiguration phase.

As seen in FIGS. 44-45-46, the mono-robot 10A is displaced so as to position the projection of the center of gravity of the poly-robot 100 within the sustenance triangle formed by the wheels 17a, 17b and 17c, as far as possible from the edges of said sustenance triangle.

The wheel 17d is then ready to cross the obstacle.

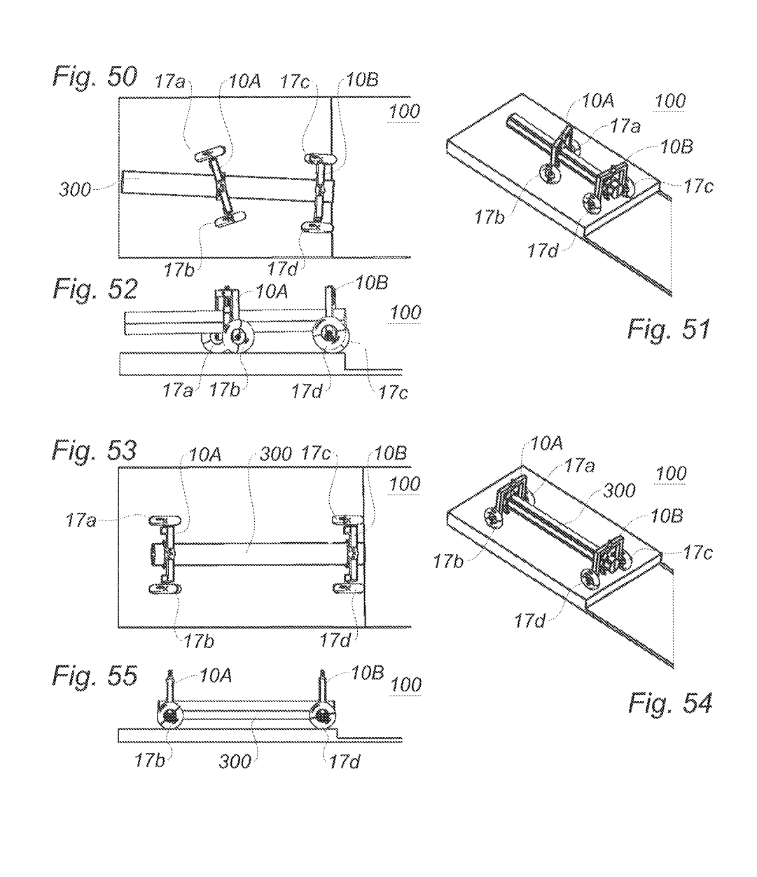

As visible in FIGS. 47-48-49, the mono-robot 10B lifts the wheel 17d. Then, the wheel 17d is positioned above the obstacle and placed on the obstacle as shown in FIGS. 50-51-52.

The poly-robot 100 having then crossed the obstacle, the mono-robots 10A and 10B are oriented in the rolling position in a straight line as visible in FIGS. 53-54-55.

The invention can also be implemented by a poly-robot 100 which comprises at least three mono-robots 10, the crossing of an obstacle may be performed by successively lifting each of the three mono-robots 10.

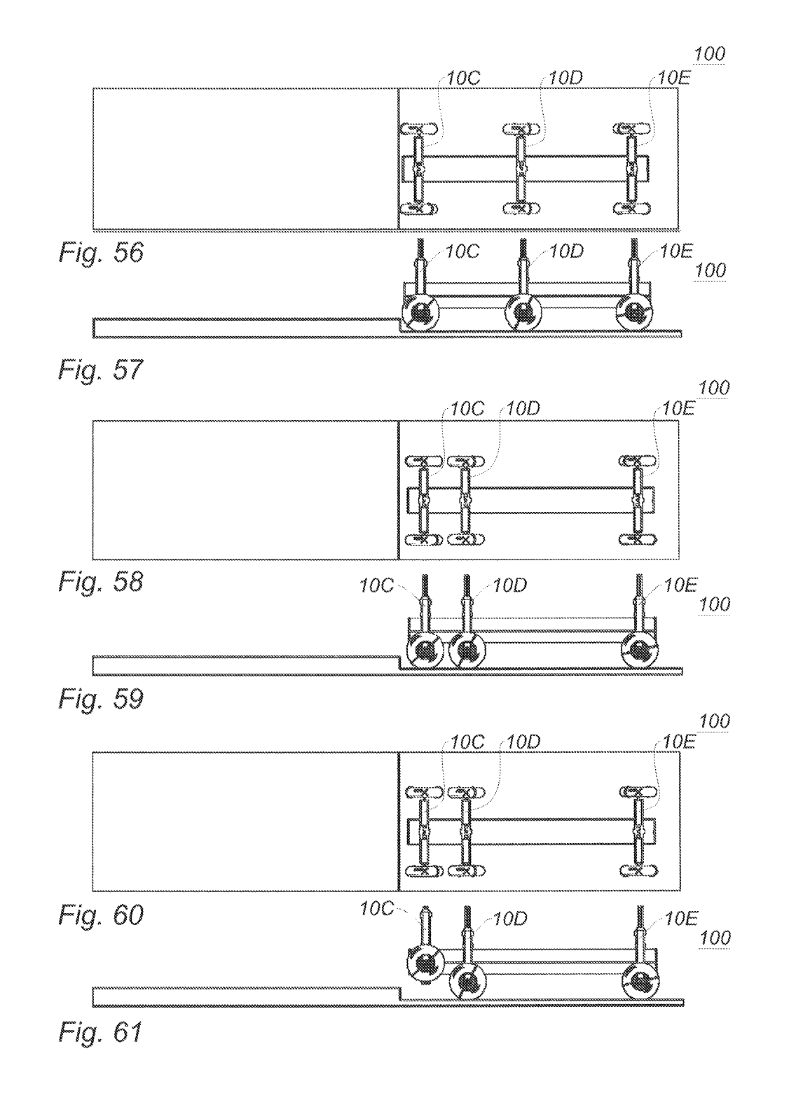

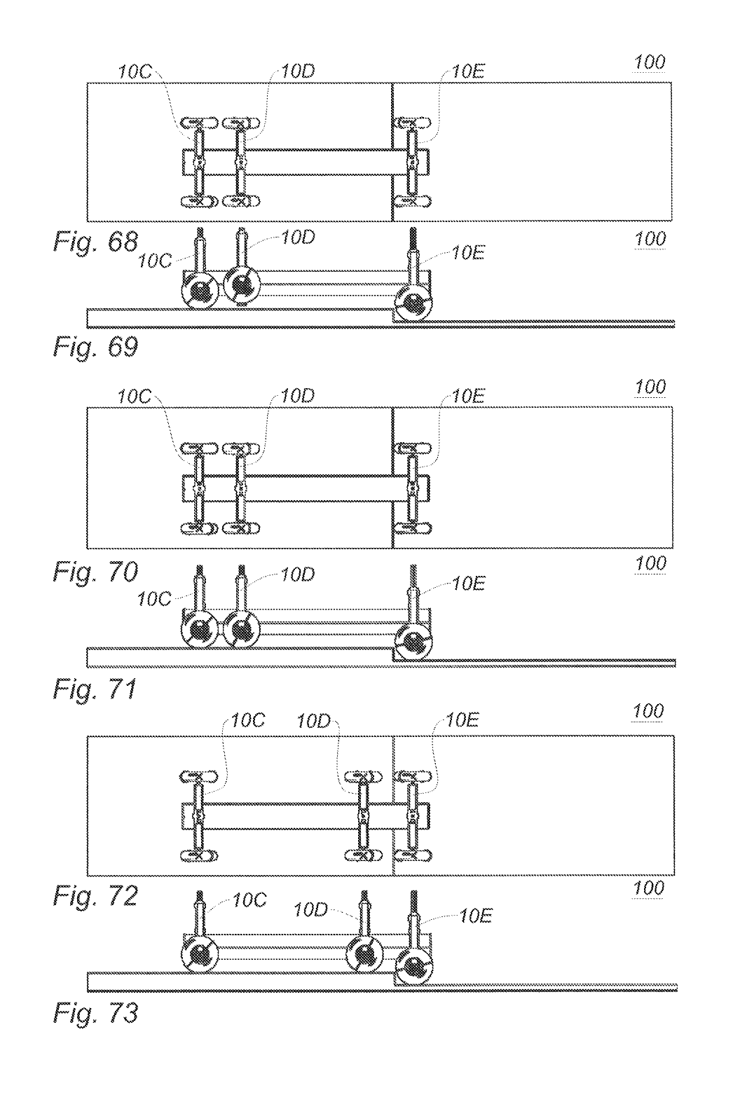

It must be specified that the invention is not limited to the poly-robot with three mono-robots illustrated in FIGS. 56 to 79. The invention may be implemented with more than three mono-robots.

During the raising of one of the mono-robots 10, the poly-robot 100 bears on the other mono-robot 10 in contact with the ground or the obstacle.

For its good understanding, the crossing method of an obstacle by a poly-robot 100 comprising at least three mono-robots 10 is described hereinafter.

During the rolling, the poly-robot 100 may meet an obstacle as illustrated in FIGS. 56-57.

As seen in FIGS. 58-59, the mono-robot 10D, by means of the prismatic connection Pd, is displaced along the load 300 to reconfigure the balance of the poly-robot 100 for lifting the mono-robot 10C.

As seen in FIGS. 60-61, the mono-robot 100 then performs a translation of substantially vertical axis, due to the cylindrical connection Cc, so as to be lifted at an altitude greater than the altitude of the obstacle.

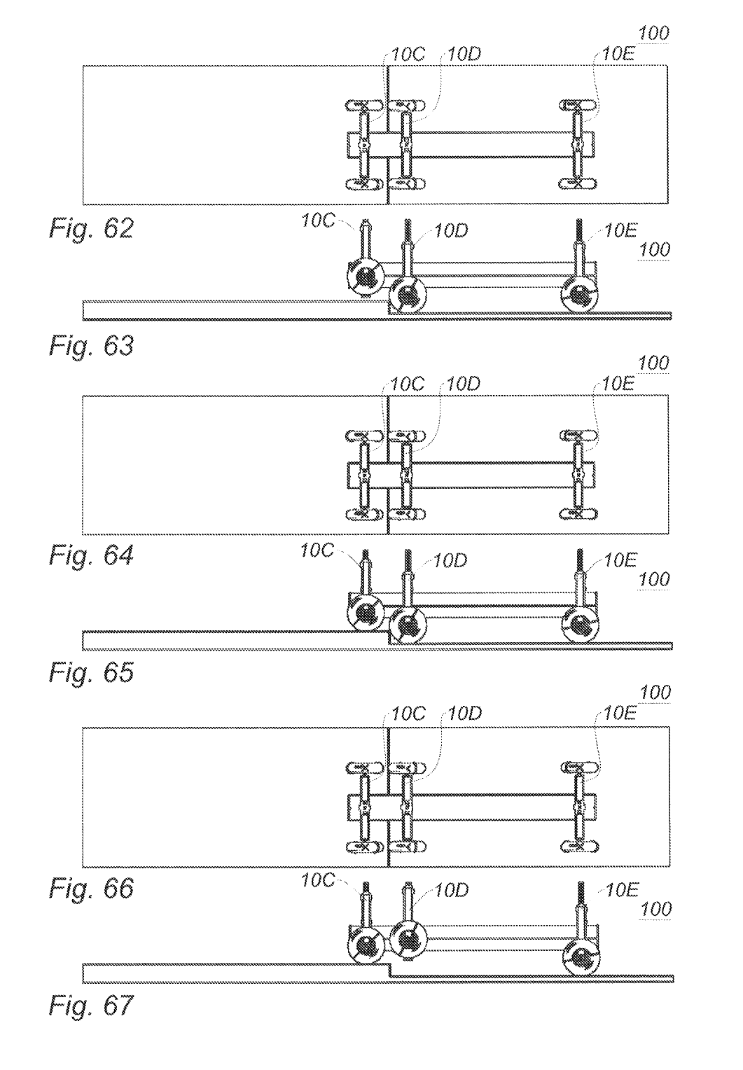

As seen in FIGS. 62-63, the two mono-robots 10D-10E which serve as bearing for the poly-robot 100 move forward to position the mono-robot 100 over the obstacle.

As seen in FIGS. 64-65, the mono-robot 100 performs a translation of substantially vertical axis to be placed on the obstacle.

The poly-robot 100 moves forward to position the mono-robot 10D against the obstacle, as observable in FIGS. 64-65.

In the same way as the mono-robot 100 the mono-robot 10D is raised then placed on the obstacle, as seen in FIGS. 66 to 71.

The poly-robot 100 moves forward to position the mono-robot 10E against the obstacle.

In order to lift the mono-robot 10E, the mono-robot 10D performs a translation along the load 300 to ensure the stability of the poly-robot 100, as it may be seen in FIGS. 72-73.

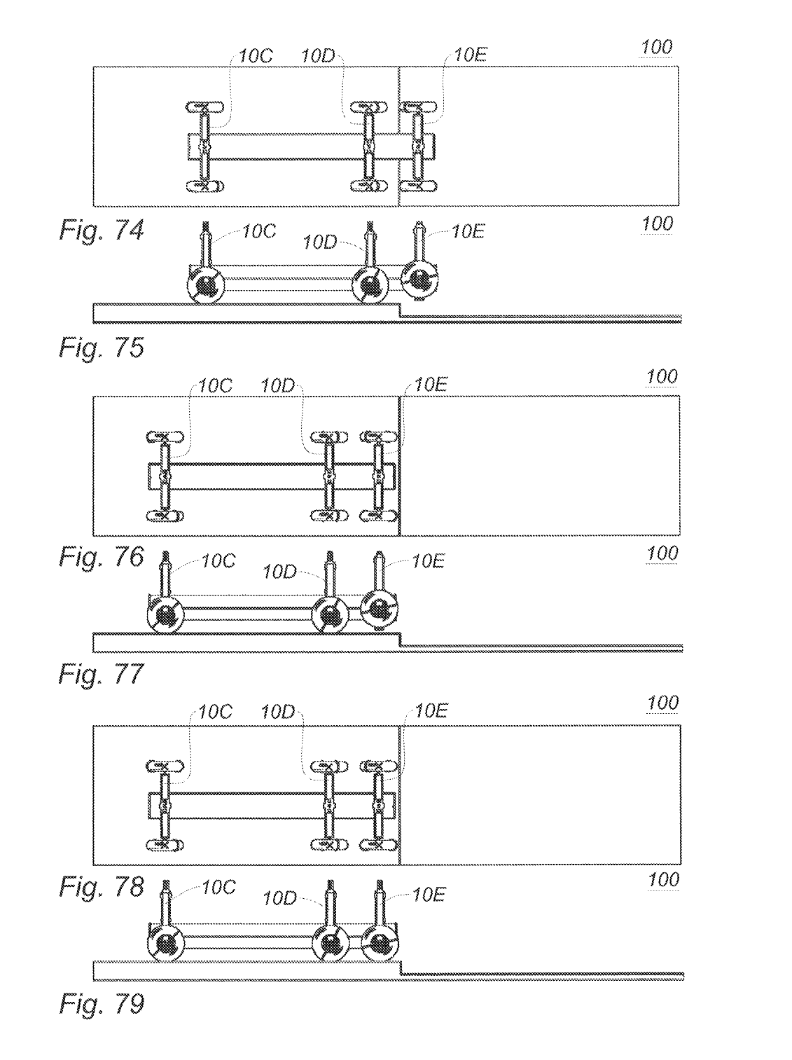

In the same manner as the mono-robots 100 and 10D, the mono-robot 10E is raised then placed on the obstacle, as observable in FIGS. 74 to 79.

Of course, the invention is not limited to the embodiments shown hereinabove, but it encompasses, on the contrary, all the variants, in particular the case where the poly-robot includes a number M of mono-robots greater than three and alternative propulsion means, such as omnidirectional wheels or caterpillars as an alternative of the represented wheels.

1. A load transporting mono-robot comprising (i) a gantry crane with two lateral uprights connected at their upper ends by a transverse beam, each of the lower ends being equipped with propulsion means connected to the upright by a driven pivot, and (ii) means for gripping a load positioned between the lateral uprights connected to the transverse beam by a positioning and orientation kinematic chain configured to allow the rotation of the gripping means of a load about an axis substantially normal to the transverse beam and substantially belonging to the plane defined by the gantry crane, and the rotation of the gripping means of a load about an axis substantially normal to the plane defined by the gantry crane.

2. The load transporting mono-robot according to claim 1, characterized in that the positioning and orientation kinematic chain connecting the gripping means to the transverse beam is configured to allow the translation of the gripping means of a load along a direction substantially normal to the plane defined by the gantry crane.

3. The load transporting mono-robot according to claim 1, characterized in that the positioning and orientation kinematic chain connecting the gripping means to the transverse beam is configured to allow the translation of the gripping means of a load along a direction substantially normal to the transverse beam and substantially belonging to the plane defined by the gantry crane.

4. The mono-robot according to any of claims 1, characterized in that the gripping means of a load are connected to the transverse beam by a positioning and orientation kinematic chain comprising the connections:
cylindrical (C), rotoid (R1), prismatic (P) or universal (U).

5. The mono-robot according to claim 1, characterized in that the propulsion means belong to the group comprising: a wheel, a caterpillar and omnidirectional wheel.

6. The mono-robot according to claim 1, characterized in that the gripping means of a load comprise a clamp having one or more jaws configured to seize and retain a load, each jaw being equipped with a end roller movable in rotation relative to the jaws and allowing the translation of a load relative to the jaws, and at least one latch adapted to immobilize in rotation one or more rollers relative to the corresponding jaws.

7. A method for transporting a load by a load transporting poly-robot, characterized in that the method comprises the following steps:
supply of a number M of mono-robots with M greater than or equal to 2, according to any of claims 1 to 6;
distribution of the mono-robots along a load;
gripping by the gripping means of each mono-robot of a load or an intermediate chassis connected to a load;
lifting of the load;
actuation of the propulsion means of each mono-robot.

8. The method of transporting a load according to claim 7, characterized in that it comprises the following phases of crossing an obstacle:
positioning of the poly-robot against an obstacle;
for each mono-robot m (m=1 . . . M) of the poly-robot:
reconfiguration phase of the assembly of the poly-robot to maximize its stability in anticipation of the raising of a propulsion means of the mono-robot m;
raising of a first propulsion means of the mono-robot m at an altitude greater than the altitude of the obstacle;
crossing phase of the obstacle by the first propulsion means of the mono-robot m;
landing phase on the obstacle of the first propulsion means of the mono-robot m;
reconfiguration phase of the assembly of the poly-robot to maximize its stability in anticipation of the raising of the second propulsion means of the mono-robot m;
raising of the second propulsion means of the mono-robot m at an altitude greater than the altitude of the obstacle;
crossing phase of the obstacle by the second propulsion means of the mono-robot m;
landing phase on the obstacle of the second propulsion means of the mono-robot m.

9. The method for transporting a load according to claim 7, characterized in that the reconfiguration phase comprises one or more of the following steps and intended for the stabilization:
translation of substantially longitudinal axis of a mono-robot relative to the load so as to approach said mono-robot to the center of gravity of the load;
rotation of substantially vertical axis of a mono-robot m relative to the load so as to approach a propulsion means bearing on the ground of the mono-robot m to the position of the propulsion means which will be subsequently lifted by a mono-robot m+1.

10. The method for transporting a load of a load transporting poly-robot (100) comprising two mono-robots according to claim 7 characterized in that the crossing phase of an obstacle comprises the following steps:
rotation of substantially longitudinal axis of a mono-robot allowing the positioning, at an altitude greater than the altitude of the obstacle, of the propulsion means which crosses the obstacle;
rotation of substantially vertical axis of the mono-robot allowing the positioning of the propulsion means lifted above the obstacle;
rotation of substantially longitudinal axis of the mono-robot allowing the propulsion means to be placed on the obstacle.

11. The method for transporting a load by a load transporting poly-robot according to claim 7 comprising at least three mono-robots, characterized in that it comprises the front crossing phases of an obstacle comprising:
positioning the load transporting poly-robot against an obstacle;
for each of the successive mono-robots of the poly-robot, a front crossing phase in three steps:
reconfiguration of the poly-robot in order to ensure the stability during the stability during a next raising of the mono-robot m;
translation of substantially vertical axis of a mono-robot m at an altitude greater than the altitude of the obstacle;
advance of the poly-robot and the load over the obstacle until bringing the next mono-robot m+1 against the obstacle;
translation of substantially vertical axis of the mono-robot m to allow it to place its propulsion means on the obstacle.

12. The method for transporting a load according to claim 8, characterized in that the reconfiguration phase comprises one or more of the following steps and intended for the stabilization:
translation of substantially longitudinal axis of a mono-robot relative to the load so as to approach said mono-robot to the center of gravity of the load;
rotation of substantially vertical axis of a mono-robot m relative to the load so as to approach a propulsion means bearing on the ground of the mono-robot m to the position of the propulsion means which will be subsequently lifted by a mono-robot m+1.

13. The method for transporting a load of a load transporting poly-robot comprising two mono-robots according to claim 12 characterized in that the crossing phase of an obstacle comprises the following steps:
rotation of substantially longitudinal axis of a mono-robot allowing the positioning, at an altitude greater than the altitude of the obstacle, of the propulsion means which crosses the obstacle;
rotation of substantially vertical axis of the mono-robot allowing the positioning of the propulsion means lifted above the obstacle;
rotation of substantially longitudinal axis of the mono-robot allowing the propulsion means to be placed on the obstacle.

14. The method for transporting a load of a load transporting poly-robot comprising two mono-robots according to claim 8 characterized in that the crossing phase of an obstacle comprises the following steps:
rotation of substantially longitudinal axis of a mono-robot allowing the positioning, at an altitude greater than the altitude of the obstacle, of the propulsion means which crosses the obstacle;
rotation of substantially vertical axis of the mono-robot allowing the positioning of the propulsion means lifted above the obstacle;
rotation of substantially longitudinal axis of the mono-robot allowing the propulsion means to be placed on the obstacle.

15. The method for transporting a load of a load transporting poly-robot comprising two mono-robots according to claim 9 characterized in that the crossing phase of an obstacle comprises the following steps:
rotation of substantially longitudinal axis of a mono-robot allowing the positioning, at an altitude greater than the altitude of the obstacle, of the propulsion means which crosses the obstacle;
rotation of substantially vertical axis of the mono-robot allowing the positioning of the propulsion means lifted above the obstacle;
rotation of substantially longitudinal axis of the mono-robot allowing the propulsion means to be placed on the obstacle.

16. The load transporting mono-robot according to claim 2, characterized in that the positioning and orientation kinematic chain connecting the gripping means to the transverse beam is configured to allow the translation of the gripping means of a load along a direction substantially normal to the transverse beam and substantially belonging to the plane defined by the gantry crane.

17. The mono-robot according to claim 2, characterized in that the gripping means of a load are connected to the transverse beam by a positioning and orientation kinematic chain comprising the connections: cylindrical (C), rotoid (R1), prismatic (P) or universal (U).

18. The mono-robot according to claim 3, characterized in that the gripping means of a load are connected to the transverse beam by a positioning and orientation kinematic chain comprising the connections: cylindrical (C), rotoid (R1), prismatic (P) or universal (U).

19. The mono-robot according to claim 18, characterized in that the propulsion means belong to the group comprising: a wheel, a caterpillar and omnidirectional wheel.

20. The mono-robot according to any of claim 19, characterized in that the gripping means of a load comprise a clamp having one or more jaws configured to seize and retain a load, each jaw being equipped with a end roller movable in rotation relative to the jaws and allowing the translation of a load relative to the jaws, and at least one latch adapted to immobilize in rotation one or more rollers relative to the corresponding jaws.
